(19) United States
(12) Patent Application Publication
(10) Pub. No.: US 2009/0285191 A1
(43) Pub. Date: Nov. 19, 2009

(54) METHOD AND APPARATUS FOR ENHANCING TRANSMISSION EFFICIENCY OF A WIRELESS LOCAL AREA NETWORK

(76) Inventor: Cun-Wei Fang, Tainan City (TW)

Correspondence Address: NORTH AMERICA INTELLECTUAL PROPERTY CORPORATION, P.O. BOX 506, MERRIFIELD, VA, 22116, US

(21) Appl. No.: 12/426,298

(22) Filed: Apr. 20, 2009

(30) Foreign Application Priority Data
May 15, 2008 (TW) 097117821

(51) Int. Cl. H04W 84/12

(52) U.S. Cl. 370/338

(57) ABSTRACT

A method for enhancing transmission efficiency of an access point in a wireless local area network includes generating a threshold, which is a maximum service number of clients in Unscheduled Automatic Power Save Delivery (UAPSD) mode of the access point, and a number of counts of packet retransmissions, counting a number of clients currently in UAPSD mode, and adjusting the number of counts of packet retransmissions according to the number of clients currently in UAPSD mode and the threshold.

### BACKGROUND OF THE INVENTION

1. Field of the Invention

The present invention relates to a method and a device thereof for a wireless local area network, and more particularly, to a method and a device thereof for adjusting a number of counts of packet retransmissions of an access point and adjusting a timing for entering a power save mode for a corresponding client according to a number of clients currently in Unscheduled Automatic Power Save Delivery (UAPSD) mode in order to enhance transmission efficiency of the wireless local area network.

2. Description of the Prior Art

With the popularity of wireless local area network (wireless LAN), there is a growing demand for multimedia applications for wireless LAN clients. For an access point (AP), it is a challenge to keep packet transmission rate high and at the same time achieve real-time transmission under heavy traffic. Therefore, operations of the AP have to be improved to meet requirements of wireless LAN clients. For a wireless LAN client, a power saving mechanism has also to be improved for saving power consumption to extend standby time of the client.

Unscheduled Automatic Power Save Delivery, also known as UAPSD, is a conventional power saving mechanism in present wireless LAN technologies. In UAPSD, a client sends trigger frames periodically to the AP to request transmissions. The client continues to listen to the AP until it receives an end of service period (EOSP) frame from the AP, and then goes into a power save mode. When there are too many clients in UAPSD mode in the service area of the AP, the AP becomes very busy so that transmission efficiency of the AP is quickly reduced. In addition, the client may not receive the EOSP frame due to a poor communication environment, and has no way to go into the power save mode, resulting in unnecessary power consumption.

From the above, the conventional UAPSD cannot be flexibly adjusted according to traffic loading and quality of communication environment. Therefore, it cannot solve the problem of poor transmission efficiency when the AP is overloaded.

### SUMMARY OF THE INVENTION

It is therefore a primary objective of the claimed invention to provide a method and a device thereof for enhancing transmission efficiency of an access point and a client in a wireless local area network.

The present invention discloses a method for enhancing transmission efficiency of an access point in a wireless local area network. The method comprises: generating a threshold, which is a maximum service number of clients in Unscheduled Automatic Power Save Delivery (UAPSD) mode of the access point, and a number of counts of packet retransmissions; counting a number of clients currently in UAPSD mode; and adjusting the number of counts of packet retransmissions according to the number of clients currently in UAPSD mode and the threshold.

The present invention further discloses a device for an access point in a wireless local area network. The device comprises a generation unit, a counting unit and a control unit. The generation unit is utilized for generating a threshold, which is a maximum service number of clients in Unscheduled Automatic Power Save Delivery (UAPSD) mode of the access point, and a number of counts of packet retransmissions. The counting unit is utilized for counting a number of clients currently in UAPSD mode. The control unit is coupled to the generation unit and the counting unit, and is utilized for adjusting the number of counts of packet retransmissions according to the number of clients currently in UAPSD mode and the threshold.

The present invention further discloses a method for enhancing transmission efficiency of a client in a wireless local area network. The method comprises: receiving a first number and a threshold transmitted by an access point in the wireless local area network, wherein the first number is a number of clients currently in Unscheduled Automatic Power Save Delivery (UAPSD) mode, and the threshold is a maximum service number of clients in UAPSD mode of the access point: decreasing a wait time for waiting for packet retransmission when the first number is greater than the threshold: and entering a power save mode.

The present invention further discloses an electronic device for a client in a wireless local area network. The electronic device comprises a reception unit and a control unit. The reception unit is utilized for receiving a first number and a threshold transmitted by an access point in the wireless local area network, wherein the first number is a number of clients currently in Unscheduled Automatic Power Save Delivery (UAPSD) mode, and the threshold is a maximum service number of clients in UAPSD mode of the access point. The control unit is coupled to the reception unit, and is utilized for decreasing a wait time for waiting for packet retransmission when the first number is greater than the threshold, and controlling the client to enter a power save mode.

The present invention further discloses a method for enhancing transmission efficiency of a wireless local area network comprising an access point and a plurality of clients. The method comprises: generating a threshold, which is a maximum service number of clients in Unscheduled Automatic Power Save Delivery (UAPSD) mode of the access point, and a number of counts of packet retransmissions; counting a number of clients currently in UAPSD mode; adjusting the number of counts of packet retransmissions according to the number of clients currently in UAPSD mode and the threshold; receiving the number of clients currently in UAPSD mode and the threshold by one of the plurality of clients; decreasing a wait time for waiting for packet retransmission when the number of clients currently in UAPSD mode is greater than the threshold; and controlling the one of the plurality of clients to enter a power save mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1, FIG. 3 and FIG. 5 are flowcharts of processes according to embodiments of the present invention.

FIG. 2 and FIG. 4 are schematic diagrams of electrical devices according to embodiments of the present invention.

### DETAILED DESCRIPTION

The embodiments of the present invention aim to improve operations of Unscheduled Automatic Power Save Delivery (UAPSD) so that transmission efficiency of an access point (AP) is enhanced when the AP is overloaded. At the same time, the embodiments of the present invention also adjust operation modes of a client, for saving power consumption of the client.

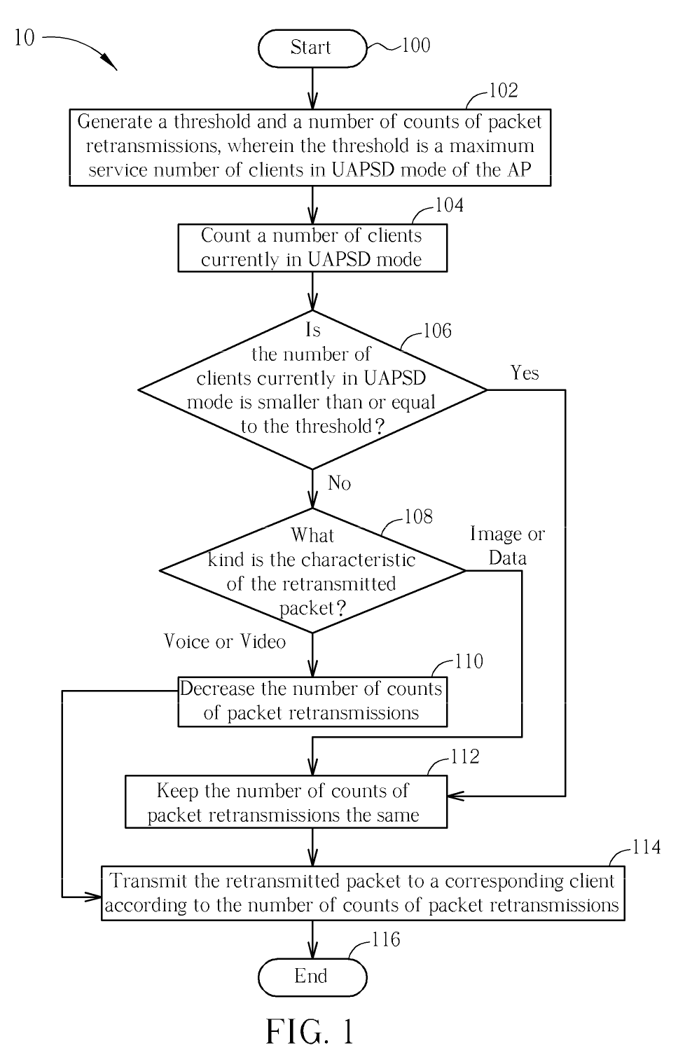

Please refer to FIG. 1, which is a flowchart of a process 10 according to an embodiment of the present invention. The process 10 is utilized for enhancing throughput of an AP in a wireless LAN and comprises the following steps:

Step 100: Start.

Step 102: Generate a threshold and a number of counts of packet retransmissions, wherein the threshold is a maximum service number of clients in UAPSD mode of the AP.

Step 104: Count a number of clients currently in UAPSD mode.

Step 106: Adjust the number of counts of packet retransmissions according to the number of clients currently in UAPSD mode and the threshold. If the number of clients currently in UAPSD mode is smaller than or equal to the threshold, perform Step 112; otherwise, perform Step 108.

Step 108: Adjust the number of counts of packet retransmissions according to a characteristic of a retransmitted packet. If the characteristic of the retransmitted packet is voice or video, perform Step 110; otherwise, if the characteristic of the retransmitted packet is image or data, perform Step 112.

Step 110: Decrease the number of counts of packet retransmissions and perform Step 114.

Step 112: Keep the number of counts of packet retransmissions the same.

Step 114: Transmit the retransmitted packet to a corresponding client according to the number of counts of packet retransmissions.

Step 116: End.

In the process 10, the threshold is the maximum service number of clients in UAPSD mode of the AP, which is generated and stored by the AP. The AP also generates the number of counts of packet retransmissions. Next, the AP counts the number of clients currently in UAPSD mode and adjusts the number of counts of packet retransmissions according to the number of clients currently in UAPSD mode and the threshold. The AP adjusts the number of counts of packet retransmissions or keeps the number the same according to a comparison result of the number of clients currently in UAPSD mode and the threshold. When the number of clients currently in UAPSD mode is smaller than or equal to the threshold, it means that the AP is not overloaded yet; the AP performs Step 112 and 114 to keep the number of counts of packet retransmissions the same, and transmits the retransmitted packet to the corresponding client according to the number of counts of packet retransmissions. On the other hand, when the number of clients currently in UAPSD mode is greater than the threshold, it means that the AP is already overloaded, and excess packet data result in a decrease in transmission efficiency. In this situation, the AP performs Step 108 to adjust the number of counts of packet retransmissions according to the characteristic of the retransmitted packet.

In the situation of AP overloading, when the characteristic of the retransmitted packet is voice or video, the AP performs Step 110 and 114 to decrease the number of counts of packet retransmissions and transmit the retransmitted packet to the corresponding client according to the decreased number of counts of packet retransmissions. When the characteristic of the retransmitted packet is image or data (the retransmitted packet being recognized has a great influence on the corresponding client), the AP still performs Step 112 and 114 that keeps the number of counts of packet retransmissions the same, and transmits the retransmitted packet to the corresponding client according to the number of counts of packet retransmissions.

From the above, according to the process 10, the AP adjusts the number of counts of packet retransmissions or to keeps it the same according to the characteristic of the retransmitted packet when the AP is overloaded. Therefore, the AP does not spend unnecessary resources for retransmitting voice and video, so that transmission efficiency of the AP is enhanced.

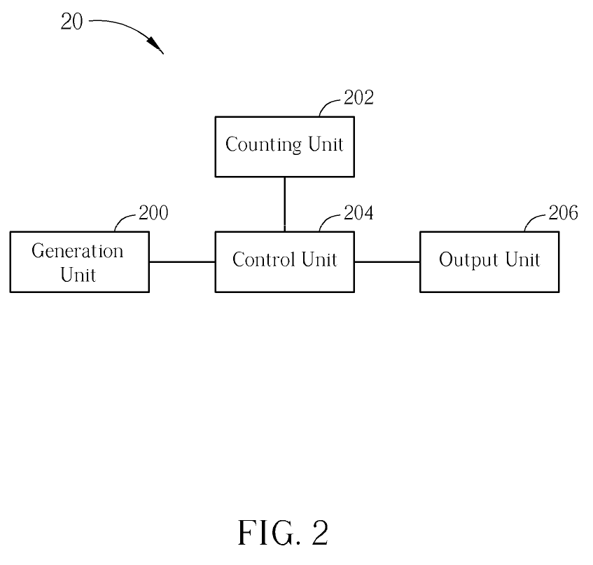

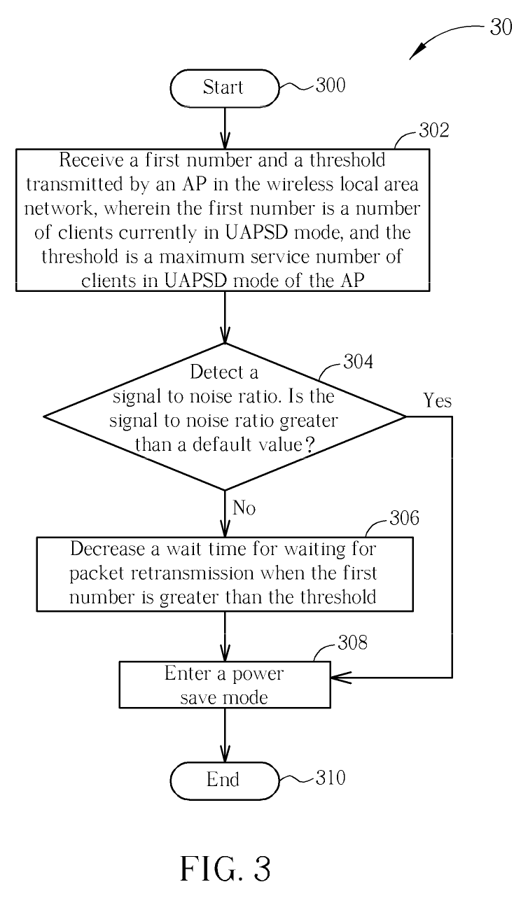

Please refer to FIG. 2 for an illustration of a hardware implementation of the process 10. FIG. 2 is a schematic diagram of an electronic device 20 according to an embodiment of the present invention. The electronic device 20 is utilized in the AP, for enhancing transmission efficiency of the AP, and comprises a generation unit 200, a counting unit 202, a control unit 204 and an output unit 206. The generation unit 200 is utilized for generating the threshold and the number of counts of packet retransmissions. The counting unit 202 is utilized for counting the number of clients currently in UAPSD mode. The control unit 204 is coupled to the generation unit 200 and the counting unit 202, and is utilized for adjusting the number of counts of packet retransmissions according to the number of clients currently in UAPSD mode counted by the counting unit 202 and the threshold generated by the generation unit 200.

When the number of clients currently in UAPSD mode is smaller than or equal to the threshold, the control unit 204 keeps the number of counts of packet retransmissions the same. When the number of clients currently in UAPSD mode is greater than the threshold, the control unit 204 adjusts the number of counts of packet retransmissions according to the characteristic of the retransmitted packet. The operations of the control unit 204 are detailed in the process 10 in FIG. 1 and therefore are not repeated here. In addition, the output unit 206 is coupled to the control unit 204, and utilized for transmitting the retransmitted packet to the corresponding client according to the number of counts of packet retransmissions.

In summary, the AP generates the threshold and the number of counts of packet retransmissions, counts the number of clients currently in UAPSD mode, and adjusts the number of counts of packet retransmissions according to the characteristic of the retransmitted packet via the electronic device 20. Therefore, the AP can flexibly decrease transmission loading via the electronic device 20 when the AP is overloaded, for enhancing transmission efficiency of the AP and saving power consumption of the AP.

Please refer to FIG. 3, which is a flowchart of a process 30 according to an embodiment of the present invention. The process 30 is utilized for enhancing transmission efficiency of a client in the wireless LAN, and comprises the following steps:

Step 300: Start.

Step 302: Receive a first number and a threshold transmitted by an AP in the wireless local area network, wherein the first number is a number of clients currently in UAPSD mode, and the threshold is a maximum service number of clients in UAPSD mode of the AP.

Step 304: Detect a signal to noise ratio. If the signal to noise ratio is greater than a default value, perform Step 308; otherwise, perform Step 306.

Step 306: Decrease a wait time for waiting for packet retransmission when the first number is greater than the threshold.

Step 308: Enter a power save mode.

Step 310: End.

According to the process 30, the client receives the number of clients currently in UAPSD mode and receives the maximum service number of clients in UAPSD mode of the AP for later use. In addition, the client also detects the signal to noise ratio in the communications environment. Please note that Step 302 and 304 can be performed at the same time. When the detected signal to noise ratio is greater than the default value, it means that the client is located in a poor communications environment and may not receive an End of Service Period (EOSP) frame, so that the client enters the power save mode immediately for saving power consumption. When the detected signal to noise ratio is smaller than or equal to the default value and the first number is greater than the threshold, the client decreases the wait time for waiting for packet retransmission. It should be noted that the process 30 is one embodiment of the present invention, and those skilled in the art can make alterations and modifications accordingly. For example, in another embodiment of the present invention, Step 304 is ignored; or, the process 30 only performs Step 304 without Step 302 and 306; or, Step 306 and 308 are changed and combined so that the power save mode is entered when the first number is greater than the threshold.

In the prior art, the client can only enter the power save mode once the EOSP frame is received. In comparison, according to the process 30, the client determines the timing to enter the power save mode according to the number of clients currently in UAPSD mode and the signal to noise ratio, so that power consumption of the client is saved.

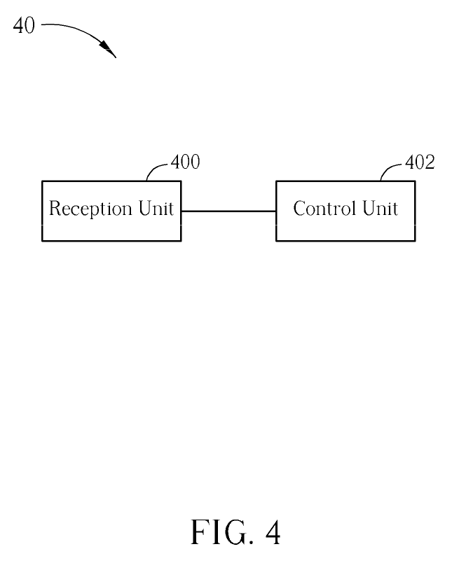

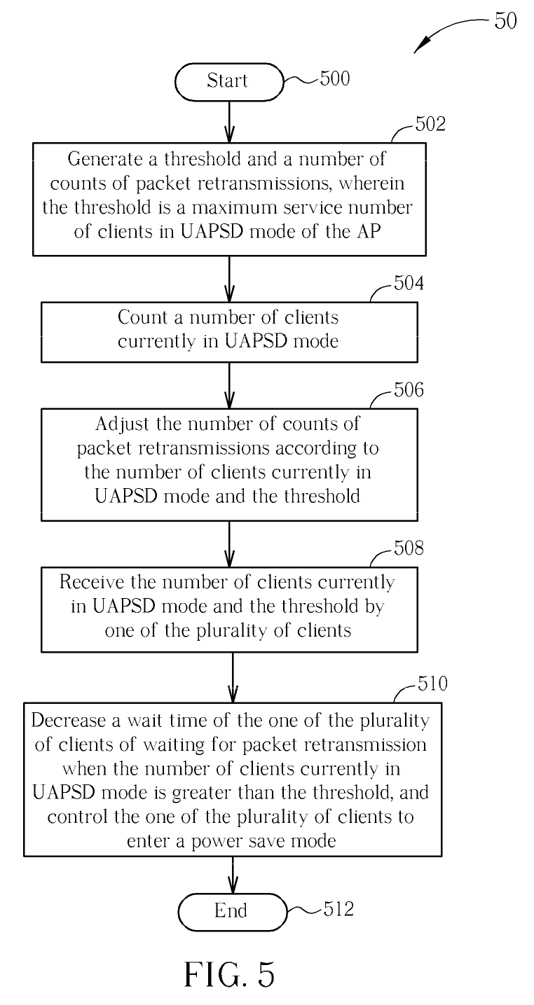

Please refer to FIG. 4 for an illustration of a hardware implementation of the process 30. FIG. 4 is a schematic diagram of an electronic device 40 according to an embodiment of the present invention. The electronic device 40 is utilized in the client, for enhancing transmission efficiency of the client. The electronic device 40 comprises a reception unit 400 and a control unit 402. The reception unit 400 is utilized for receiving two numbers, the first number and the threshold, as described in the process 30. The control unit 402 is coupled to the reception unit 400, and is utilized for decreasing the wait time for waiting for packet retransmission when the first number is greater than the threshold, and controlling the client to enter the power save mode.

For example, when the first number is smaller than or equal to the threshold, the AP which serves the client is normally loaded, and the wait time for the client is 15 msec: that is, the client enters the power save mode after waiting 15 msec. When the first number is greater than the threshold, the AP is overloaded, and so the client decreases the wait time to 5 msec: that is, the client enters the power save mode after waiting 5 msec even if the client does not receive the EOSP frame. The control unit 402 is further utilized for detecting the signal to noise ratio in the communications environment where the client is located, and controlling the client to enter the power save mode when the signal to noise ratio is greater than the default value. In another embodiment of the present invention, when the first number is greater than the threshold, the control unit 402 can also control the client to enter the power save mode immediately without decreasing the wait time. The operations of the electronic device 40 and other exemplary embodiments of the control unit 402 are detailed in the process 30 as above and therefore are not repeated here.

Form the above, the process 10 and the process 30 are respectively used in the AP and the client for enhancing transmission efficiency of the AP and the client. The embodiment of the present invention further provides a process 50, which is a combination of the process 10 and the process 30, for enhancing transmission efficiency of the wireless LAN comprising an AP and a plurality of clients. The process 50 comprises the following steps:

Step 500: Start.

Step 502: Generate a threshold and a number of counts of packet retransmissions, wherein the threshold is a maximum service number of clients in UAPSD mode of the AP.

Step 504: Count a number of clients currently in UAPSD mode.

Step 506: Adjust the number of counts of packet retransmissions according to the number of clients currently in UAPSD mode and the threshold.

Step 508: Receive the number of clients currently in UAPSD mode and the threshold by one of the plurality of clients.

Step 510: Decrease a wait time of the one of the plurality of clients of waiting for packet retransmission when the number of clients currently in UAPSD mode is greater than the threshold, and control the one of the plurality of clients to enter a power save mode.

Step 512: End.

The operations of the AP and the client in the process 50 are detailed in the process 10 and the process 30 and therefore are not repeated here.

In conclusion, according to the illustrated embodiments of the present invention, the AP flexibly adjusts the number of counts of packet retransmissions according to the number of clients currently in UAPSD mode and the characteristic of the retransmitted packet, for enhancing transmission efficiency of the AP. The client also determines the timing of entering the power save mode according to the number of clients currently in UAPSD mode and the signal to noise ratio, for saving power consumption of the client. As a result, transmission efficiency of the wireless LAN is enhanced.

Those skilled in the art will readily observe that numerous modifications and alterations of the device and method may be made while retaining the teachings of the invention.

What is claimed is:

1. A method for enhancing transmission efficiency of an access point in a wireless local area network, the method comprising:
generating a threshold, wherein the threshold is a maximum service number of clients in Unscheduled Automatic Power Save Delivery (UAPSD) mode of the access point, and a number of counts of packet retransmissions;
counting a number of clients currently in UAPSD mode; and
adjusting the number of counts of packet retransmissions according to the number of clients currently in UAPSD mode and the threshold.

2. The method of claim 1, wherein the step of adjusting the number of counts of packet retransmissions according to the number of clients currently in UAPSD mode and the threshold comprises keeping the number of counts of packet retransmissions the same when the number of clients currently in UAPSD mode is smaller than or equal to the threshold.

3. The method of claim 1, wherein the step of adjusting the number of counts of packet retransmissions according to the number of clients currently in UAPSD mode and the threshold comprises adjusting the number of counts of packet retransmissions according to a characteristic of a retransmitted packet when the number of clients currently in UAPSD mode is greater than the threshold.

4. The method of claim 3, wherein the step of adjusting the number of counts of packet retransmissions according to the characteristic of the retransmitted packet comprises decreasing the number of counts of packet retransmissions when the characteristic of the retransmitted packet is voice or video.

5. The method of claim 3, wherein the step of adjusting the number of counts of packet retransmissions according to the characteristic of the retransmitted packet comprises keeping the number of counts of packet retransmissions the same when the characteristic of the retransmitted packet is image or data.

6. The method of claim 1 further comprising:
transmitting a retransmitted packet to a corresponding client according to the number of counts of packet retransmissions.

7. A device for an access point in a wireless local area network, the device comprising:
a generation unit for generating a threshold, wherein the threshold is a maximum service number of clients in Unscheduled Automatic Power Save Delivery (UAPSD) mode of the access point, and a number of counts of packet retransmissions;
a counting unit for counting a number of clients currently in UAPSD mode; and
a control unit coupled to the generation unit and the counting unit, for adjusting the number of counts of packet retransmissions according to the number of clients currently in UAPSD mode and the threshold.

8. The device of claim 7, wherein the control unit keeps the number of counts of packet retransmissions the same when the number of clients currently in UAPSD mode is smaller than or equal to the threshold.

9. The device of claim 7, wherein the control unit adjusts the number of counts of packet retransmissions according to a characteristic of a retransmitted packet when the number of clients currently in UAPSD mode is greater than the threshold.

10. The device of claim 9, wherein the control unit decreases the number of counts of packet retransmissions when the characteristic of the retransmitted packet is voice or video.

11. The device of claim 9, wherein the control unit keeps the number of counts of packet retransmissions fixed when the characteristic of the retransmitted packet is image or data.

12. The device of claim 7 further comprising an output unit coupled to the control unit, for transmitting a retransmitted packet to a corresponding client according to the number of counts of packet retransmissions.

13. A method for enhancing transmission efficiency of a client in a wireless local area network, the method comprising:
receiving a first number and a threshold transmitted by an access point in the wireless local area network, wherein the first number is a number of clients currently in Unscheduled Automatic Power Save Delivery (UAPSD) mode, and the threshold is a maximum service number of clients in UAPSD mode of the access point;
decreasing a wait time for waiting for packet retransmission when the first number is greater than the threshold; and
entering a power save mode.

14. The method of claim 13 further comprising:
entering the power save mode without decreasing the wait time when the first number is greater than the threshold.

15. The method of claim 13 further comprising:
detecting a signal to noise ratio; and
entering the power save mode when the signal to noise ratio is greater than a default value.

16. A device for a client in a wireless local area network comprising:
a reception unit, for receiving a first number and a threshold transmitted by an access point in the wireless local area network, wherein the first number is a number of clients currently in Unscheduled Automatic Power Save Delivery (UAPSD) mode, and the threshold is a maximum service number of clients in UAPSD mode of the access point; and
a control unit coupled to the reception unit, for decreasing a wait time for waiting for packet retransmission when the first number is greater than the threshold and controlling the client to enter a power save mode.

17. The device of claim 16, wherein the control unit is further utilized for controlling the client to enter the power save mode when the first number is greater than the threshold.

18. The device of claim 16, wherein the control unit is further utilized for detecting a signal to noise ratio and controlling the client to enter the power save mode when the signal to noise ratio is greater than a default value.

19. A method for enhancing transmission efficiency of a wireless local area network comprising an access point and a plurality of clients, the method comprising:
generating a threshold, which is a maximum service number of clients in Unscheduled Automatic Power Save Delivery (UAPSD) mode of the access point, and a number of counts of packet retransmissions;
counting a number of clients currently in UAPSD mode;
adjusting the number of counts of packet retransmissions according to the number of clients currently in UAPSD mode and the threshold;
receiving the number of clients currently in UAPSD mode and the threshold by one of the plurality of clients;
decreasing a wait time for waiting for packet retransmission when the number of clients currently in UAPSD mode is greater than the threshold; and
controlling the one of the plurality of clients to enter a power save mode.

20. The method of claim 19, wherein the step of adjusting the number of counts of packet retransmissions according to the number of clients currently in UAPSD mode and the threshold comprises keeping the number of counts of packet retransmissions the same when the number of clients currently in UAPSD mode is smaller than or equal to the threshold.

21. The method of claim 19, wherein the step of adjusting the number of counts of packet retransmissions according to the number of clients currently in UAPSD mode and the threshold comprises adjusting the number of counts of packet retransmissions according to a characteristic of a retransmitted packet when the number of clients currently in UAPSD mode is greater than the threshold.

22. The method of claim 21, wherein the step of adjusting the number of counts of packet retransmissions according to the characteristic of the retransmitted packet comprises decreasing the number of counts of packet retransmissions when the characteristic of the retransmitted packet is voice or video.

23. The method of claim 21, wherein the step of adjusting the number of counts of packet retransmissions according to the characteristic of the retransmitted packet comprises keeping the number of counts of packet retransmissions the same when the characteristic of the retransmitted packet is image or data.

24. The method of claim 19 further comprising:
controlling the one of the plurality of clients to enter the power save mode without decreasing the wait time when the number of clients currently in UAPSD mode is greater than the threshold.

25. The method of claim 19 further comprising:
detecting a signal to noise ratio; and
controlling the one of the plurality of clients to enter the power save mode when the signal to noise ratio is greater than a default value.
